(19) United States
(12) Patent Application Publication
(10) Pub. No.: US 2009/0213269 A1
(43) Pub. Date: Aug. 27, 2009

(54) Content Slider

(76) Inventors: David Dozoretz, Los Angeles, CA (US); Hunter Kuhnert, Santa Monica, CA (US)

Correspondence Address: CARR & FERRELL LLP, 2200 GENG ROAD, PALO ALTO, CA, 94303, US

(21) Appl. No.: 12/316,033

(22) Filed: Dec. 8, 2008

Related U.S. Application Data
(60) Provisional application No. 61/066,659, filed on Feb. 21, 2008.

(51) Int. Cl. H04N 5/445

(52) U.S. Cl. 348/563; 348/E05.001

(57) ABSTRACT

Systems and methods include displaying information associated with various media and/or items of media content. Certain aspects include receiving input that identifies a parameter characterizing one or more media or items of content. A plurality of values for the parameter may be identified, and in some cases, the plurality may be ordered. Each value may be associated with one or more items of content characterized by the parameter. Input that identifies a first set of the plurality may be received, and a monitor may be instructed to display information associated with the first set. Various aspects include the display of a control bar, which may include a slider. In some cases, the receipt of input includes receiving a signal from a remote control. In certain cases, input may be associated with operation of a control bar and/or a slider.

### CROSS REFERENCE TO RELATED APPLICATIONS

This application claims the priority benefit of U.S. provisional patent application No. 61/066,659 entitled “Viewer User Interface” filed Feb. 21, 2008, the disclosure of which is incorporated herein by reference.

### BACKGROUND

1. Field of Invention

The present invention relates generally to user interfaces, and more particularly to finding and choosing content from among a plurality of choices.

2. Description of Related Art

A broad variety of media (or items of content) is available for a user's consumption—movies, songs, television shows, pictures, sporting events, web pages and the like. A large number of such items exist, and a user (i.e., viewer, listener, or other consumer) of media typically chooses a preferred item from a large set of possible choices. For example, a user may wish to choose from among thousands of movies, hundreds of thousands of songs, millions of web pages, or other large numbers of media items.

As the diversity and number of available media increases, a user's choice of an item may be made from a larger and larger set of options. For very large sets, finding and choosing a desired item of content may be tiresome. In some cases, media enjoyment may be reduced because finding a desired item in a large set of options is tedious.

A typical user interface may present a user with a two dimensional (2D) display of choices. This display typically has a well known, predefined dimensionality. For example, a display may show a user “television channel” in a vertical dimension, “time” in a horizontal dimension, and boxes on the screen correspond to a program to be displayed on a certain channel at a certain time. A user typically scrolls through channels, viewing available programs at the present time (or a short time in the future), and chooses upon identifying a desired program.

Other interfaces may let a user search by title, and in some cases, a title may be selected for immediate consumption (e.g., video on demand or playing a song on a music player). Some titles may be searched alphabetically. Such processes typically requires the a priori knowledge of which item is desired (e.g., a user searches for a particular movie), and the user interface is designed to facilitate a user's finding of a desired item of content after having already identified it. Users typically do not think “I'd like to watch a movie beginning with the letter “B”—what's available?” Rather, an already identified title is searched for.

Typical interfaces present a user with a graphical display whose dimensions are static and well known (e.g., channel vs. time). However, some users may wish to choose media based on characteristics other than those such as channel, time or title.

### SUMMARY OF THE INVENTION

Various aspects allow a user to find and choose media or other content from among a plurality of choices. Media may be characterized by one or more parameters, and a value for a parameter may be associated with and/or identify one or more particular media. Typically, a parameter characterizes an item of content by describing, identifying, or otherwise enumerating some aspect of the item. The value for a given parameter may specify a particular setting or level or string for that parameter, and may be unique to an item or shared among items. For example, media may be characterized by a TITLE parameter, and TITLE may take a value having the title of a particular movie, TV show, song, sporting event, broadcast, or other media. Media may be characterized by a GENRE parameter, and GENRE may take values such as “comedy” or “sci-fi” or “action” and the like.

A user may generally choose one or more desired parameters, and identify one or more ranges of values for these parameters. Information associated with various media, parameters, and their respective values may be displayed, and a user may operate one or more control bars to select desired ranges of values. In some cases, a range of values is selected using a slider, which may identify a boundary between values having their associated information displayed and values for which information is not displayed.

Various aspects include receiving a first input that identifies a parameter that characterizes one or more media. A plurality of values for the parameter may be identified; each value is typically associated with at least one of the media characterized by the parameter. A second input that identifies a first set of the plurality of values may be received, and instructions may be generated that instruct a monitor to display first information. Typically, the first information is associated with media having values that are within the first set.

Some aspects include displaying first information on a monitor. In some cases, a monitor may include a television. In some cases, a monitor may include a mobile phone.

In certain embodiments, a user may identify a range of values using a control bar, which may include using a slider that demarcates a boundary between values whose corresponding information is currently displayed and values whose corresponding information is not currently displayed. In some cases, a user may find and optionally select media by identifying one or more parameters of interest and selecting a range of values of interest for each identified parameter.

Certain embodiments include a computer readable storage medium having embodied thereon a program executable by a processor to perform a method. Some embodiments include a set-top box, configured to control a display on a television. Some embodiments include a television.

### BRIEF DESCRIPTION OF THE DRAWINGS

FIG. 1 is a diagrammatic representation of a media system, according to certain embodiments.

FIG. 2 is a schematic illustration of a box, according to certain embodiments.

FIGS. 3A and 3B illustrate certain aspects of a display, according to some embodiments.

FIGS. 4A-D illustrates several examples of control bars and associated information, according to certain embodiments.

FIGS. 5A-D illustrate various operations of a control bar to select ranges of values for a controlled parameter, according to certain embodiments.

FIGS. 6A-6D illustrate a relationship between operation of a control bar and a change in displayed information, according to certain embodiments.

FIGS. 7A and 7B illustrate the operation of multiple control bars on displayed information, according to certain embodiments.

FIG. 8 illustrates another display utilizing multiple control bars, according to certain embodiments.

FIG. 9 illustrates another display utilizing multiple control bars, according to certain embodiments.

FIG. 10 illustrates another display utilizing multiple control bars, according to certain embodiments.

FIGS. 11A and 11B illustrate an increase in information content with a reduced range of a controlled parameter, according to certain embodiments.

FIG. 12 is a flow chart illustrating a method, according to certain embodiments.

### DETAILED DESCRIPTION OF THE INVENTION

Various aspects allow a user to find and choose media or other content from among a plurality of choices. Media may be characterized by one or more parameters, and a value for a parameter may be associated with one or more particular media. For example, a TITLE parameter may take a value having the title of a particular movie, TV show, song, sporting event, broadcast, or other media.

A user may generally choose one or more desired parameters, and identify one or more ranges of values for these parameters. Information associated with various media, parameters, and their respective values may be displayed, and a user may operate one or more control bars to select desired parameters and associated ranges of values. In some cases, a range of values is selected using a slider, which may identify a boundary between values having their associated information displayed and values for which information is not displayed.

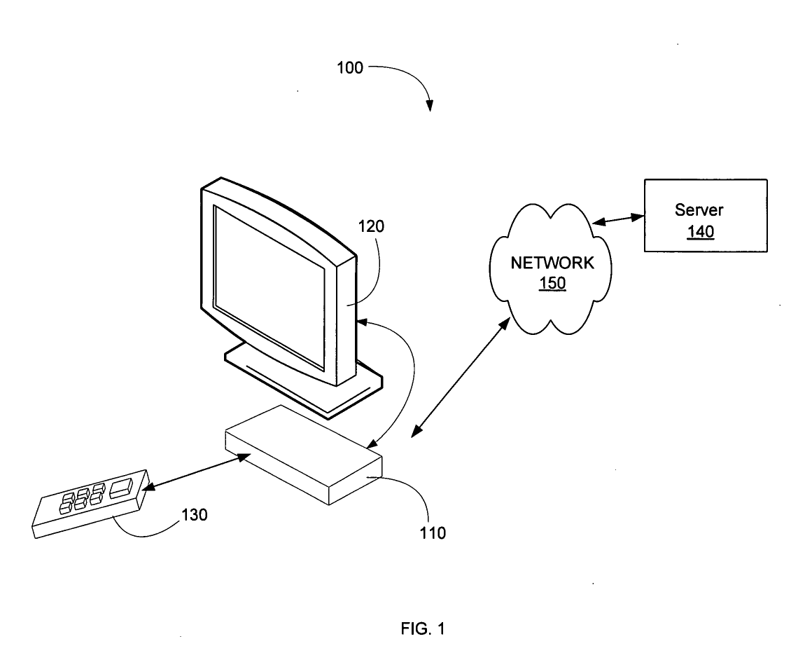

FIG. 1 is a diagrammatic representation of a media system, according to certain embodiments. Media system 100 includes a box 110 (e.g., a set-top box), configured to control monitor 120. Monitor 120 may include a display device such as a video display and/or an audio output (e.g., a speaker or headphone jack). Monitor 120 may include a flat panel display, a projection display, a cathode ray tube, a liquid crystal display, a plasma display, an OLED display, or another type of display device. In some embodiments, box 110 is physically separated from monitor 120. In other embodiments, box 110 and monitor 120 are integrated. Box 110 and monitor 120 are communicatively connected, and may communicate, for example, via electrical (e.g., S-video, HDMI), optical, and/or wireless (e.g., wireless HDMI, 802.*) connections.

A user may control box 110. In some embodiments, box 110 may be controlled using remote 130. Remote 130 communicates with box 110 (e.g., by transmitting a signal), often in response to receiving input from the user. In some embodiments, remote 130 is physically separated from box 110, and may generally communicate wirelessly with box 110 using one or more optical (e.g., infrared) and/or radio frequency (e.g., 802.*) communications protocols. In other embodiments, remote 130 is physically integrated with box 110.

Generally, the use of box 110 includes display of information on monitor 120. Information may include media content and/or associated metadata. Box 110 may receive input from a user (e.g., via remote 130), and display further information (e.g., more or less detailed information, or different information). Information may be associated with one or more items of media content, and various embodiments allow a user to identify and play one or more items of media content.

Remote 130 may be configured to allow a user to select information, parameters, items of content, and the like. Remote 130 may allow a user to operate control bars, move sliders, and identify ranges of values for display, typically within an interface provided by box 110. Remote 130 may include various buttons, accelerometers, position sensors and circuitry, feedback/actuation components and other circuitry as needed to provide for an interface between a user and various components of media system 100.

In select embodiments, box 110, monitor 120 and remote 130 are integrated, and may be components of a portable device such as a laptop, palmtop, personal digital assistant (PDA), mobile telephone, or other device.

In some implementations, box 110 stores at least a portion of one or more items of content for display on monitor 120. In some configurations, items of content and/or associated information are stored on a server 140, which may be communicatively connected to box 110 via a network 150. Network 150 may include the Internet. Network 150 may be a wide area network (WAN), a local area network (LAN), intranet, extranet, private network or other network, as well as a combination of these networks.

Network 150 may include one or more wireless networks, including various 802.11, 802.16, GSM and/or CDMA networks. In some configurations, box 110 communicates with server 140 using a standard internet protocol (IP), and may use one or more IP addresses. In some cases, communications may include encrypted information.

In certain cases, server 140 may be integrated with box 110. In such cases, network 150 may also include various wired interfaces such as a communications bus.

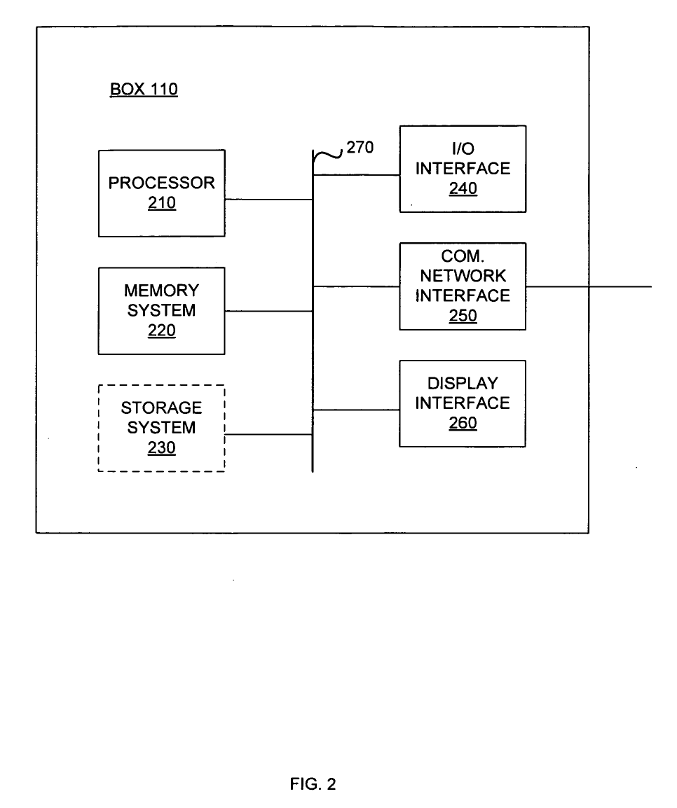

FIG. 2 is a schematic illustration of a box 110, according to certain embodiments. Box 110 includes processor 210, memory system 220, optional storage system 230, input/output (I/O) interface 240, communication network interface 250, and display interface 260. These components may be generally connected via system bus 270.

Processor 210 may be configured to execute executable instructions. In some embodiments, processor 210 comprises integrated circuits or any processor capable of processing the executable instructions. In some embodiments, processor 210 may include a cache, a multi-core processor, a video processor, and/or other processors.

Memory system 220 may be any memory configured to store data. An example of memory system 220 includes a computer readable storage medium, which may include any medium configured to store executable instructions. For example, the memory system 220 may include, but is not limited to, storage devices such as RAM, ROM, flash memory, and/or other storage devices.

Certain configurations include storage system 230 as part of box 110. In other configurations, storage system 230 may be implemented remotely, for example as part of server 140. Storage system 230 may be any storage configured to receive, store, and provide data. Storage system 230 may also include computer readable storage media such as flash memory, a hard drive, an optical drive, and/or magnetic tape. Storage system 230 may include a database or other data structure configured to hold and organize data. In some embodiments, box 110 includes memory system 220 in the form of RAM and storage system 230 in the form of flash memory.

I/O interface 240 may include hardware and/or software to interface with various devices such as remote 130, a keyboard, touchscreen, keypad, mouse, printer, scanner, or other I/O device. I/O interface 240 may receive information from a device and/or transmit information to the device.

Communication network interface 250 may communicate with various other devices, and such communications may include the use of network 150 (FIG. 1). Communication network interface 250 may support serial, parallel, USB, firewire, ethernet, and/or ATA communications. Communication network interface 250 may also support 802.11, 802.16, GSM, CDMA, EDGE and various other wireless communications protocols.

Display interface 260 may include any circuitry used to control and/or communicate with a display device, such as monitor 120. In some configurations, display interface 260 includes a video card and memory. In some configurations, monitor 120 may include a video card, and display interface 260 may communicate with the video card of monitor 120.

The functionality of various components may include the use of executable instructions, which may be stored in memory and/or computer readable storage media. In some embodiments, executable instructions may be stored in memory system 220 and/or storage system 230. Executable instructions may be retrieved and executed by processor 210, and may include software, firmware, and/or program code. Executable instructions may be executed by the processor to perform one or more methods.

Storage system 230 and/or memory system 220 may be configured to store one or more items of content (e.g., media), such as a song, video, television program, movie, web page, video, blog, and the like. An item of content may generally include or be associated with information or metadata that characterize the item. Such information may include data associated with an item's title, artist, publisher, genre, subject matter, release date and the like. Information may generally include any characteristic of an item of content.

Various embodiments may integrate and/or interact with a multidimensional database of media and associated information, which may include large amounts of information describing each item of content. Media and their associated information may be organized using a database of parameters. A parameter may be a category or type of data that may characterize an item of content, which typically takes a value according to that item's properties. For example, a parameter TITLE may include a text string corresponding to a title of a movie. A parameter GENRE may take a value “comedy” for a comedy show, comedic movie, song parody, audio comic routine and the like. Some parameters may take a unique value for each item of content. Other parameters take the same value for many items of content (e.g., “SPORTING EVENT” or “TV SHOW”). Some parameters may be rather categorical (e.g., ACTOR), other parameters may be more intrinsically numerical (e.g., TIME).

Each item of content may be characterized by a plurality (and in some cases, tens, hundreds, or even thousands) of parameters. Some parameters may describe subject matter (e.g., actors, topic, type of content), and some parameters may describe products or services represented in the subject matter (e.g., the automobile used by James Bond in a James Bond movie). In some embodiments, a user may search for an item by selecting various parameters and choosing desired values for those parameters, creating a set of options for items having those desired values. A user may subsequently narrow his or her choice by selecting progressively narrower ranges of the controlled parameters.

A parameter may characterize a plurality of items. For example, substantially all movies may be characterized by a TITLE parameter, notwithstanding that the value of TITLE for each movie is generally different.

A parameter may characterize different types of media. For example, a parameter TOPIC may take a value “Christmas,” and a user searching for associated media may be presented with Christmas movies, Christmas songs, Christmas television shows, Christmas blog entries, and Christmas-oriented web pages. In some embodiments, a choice of a particular type of media to be consumed may be made independently of the choice of other parameters.

The availability of some parameters may depend on the availability of other parameters. For example, a parameter EPISODE may be associated with a television series, but not with a song.

An item of content may be characterized by one or more unique combinations of values for its parameters. In some embodiments, a user chooses an item for consumption from a set of items sharing certain parameters. Various embodiments may allow a user to easily narrow the set and find a desired item of content.

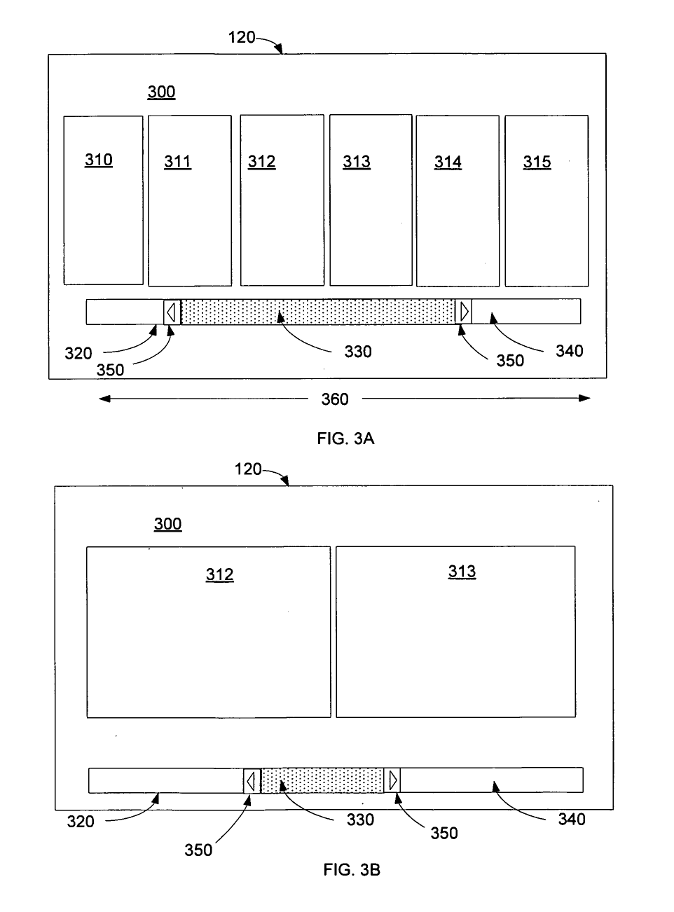

FIGS. 3A and 3B illustrate certain aspects of a display, according to some embodiments. FIG. 3A is a diagrammatic representation of a display 300 on monitor 120. Display 300 may include one or more items of information (in this example, information 310, 311, 312, 313, 314, 315), and control bar 320. Information is typically associated with one or more items of content. Control bar 320 may be used to adjust the information provided in display 300, and by extension, control the display of information 310-315. In some embodiments, control bar 320 includes an inside display region 330, an outside display region 340, and one or more sliders 350.

Information (e.g., information 310-315) may include visual and/or audible information. Information may include static information (e.g., a photograph or text) or dynamic information (e.g., a video or a stock “ticker tape” display). Information may typically be associated with values for one or more parameters associated with various items of content. Information may be specific to a single item of content, or describe several items of content. Information may include the display of an item of content per se (e.g., playing a video).

Information may be arranged as discrete items, as shown schematically in FIG. 3A by information 310-315. Information may also include substantially “continuous” information (e.g., a single item of information). Some information may benefit from discrete display, some may benefit from continuous display. For the purposes of this specification, information is displayed as discrete components for illustrative purposes only.

Control bar 320 may be characterized by a direction 360. In some embodiments, a position on control bar in with respect to direction 360 is associated with a value of a parameter being controlled by the control bar. In some cases, information on display 300 (e.g., information 310-315) is also correspondingly arranged in direction 360.

For example, a user may choose to have control bar 320 represent a parameter, and different positions along the length of control bar 320 may represent different values of the parameter. Similarly, information 310-315 may be ordered similarly in direction 360, such that the relative position of each item of information on display 300 is associated with its respective value for the parameter being controlled by control bar 320. In some cases, values for the controlled parameter are ordered, and displayed information is correspondingly ordered. For example, control bar 320 may be chosen to control a RELEASE DATE parameter associated with movie releases, ordered from early (left) to late (right) release dates in direction 360. Similarly, information 310-315 may be ordered from early (left) to late (right) release dates with respect to display 300. In such an example, information 310-315 may include release date information, and the arrangement of information 310-315 in direction 360 may convey an ordering or other relationship among the release dates of the associated media.

In some cases, control bar 320 may be operated to display the entire set of values for a parameter. In some cases, this set may be large, and each item of information may be associated with many items of content.

Sliders 350 may be operated to select a subset of values for the controlled parameter. Such selection may create inside display region 330 and outside display region 340. Inside display region 330 may correspond to values for the controlled parameter that are displayed as information on display 300. Outside display region 340 may correspond to values for the controlled parameter that are not currently displayed on display 300.

Sliders 350 may be operated to choose the boundaries between the inside display region 330 and outside display region 340. For illustrative purposes, FIG. 3B may be described as a “zoomed in” display of the information of FIG. 3A. In FIG. 3B, the location and width of inside display region 330 corresponds to a subset of values of the controlled parameter as compared to FIG. 3A. By extension, a smaller set of information (i.e., information 312 and 313) is displayed.

In some cases, “zooming in” on information may include adding more or less information to a previously displayed item of information. For example, information 312 in FIG. 3B may include more detail than corresponding information 312 in FIG. 3A. In some embodiments, a user chooses a parameter for control by control bar 320, operates one or both sliders 350 to select a range of values for the controlled parameter, and the display reflects information associated with the chosen range.

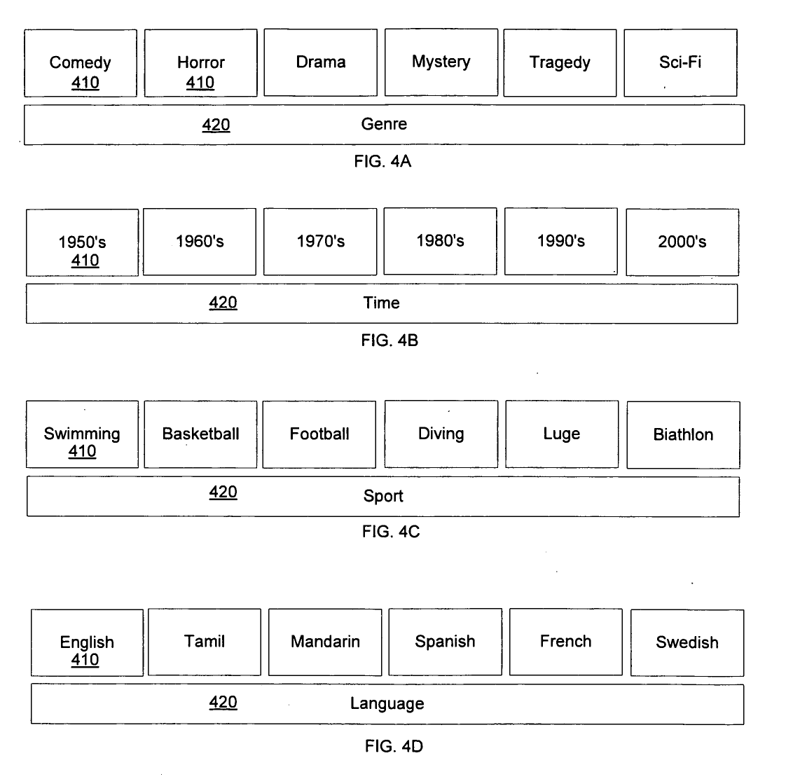

FIGS. 4A-D illustrates several examples of control bars and associated information. These examples are for illustrative purposes only, and not intended to be limiting. Sliders and various regions are omitted for clarity.

FIG. 4A illustrates a representative control bar 420 controlling the display of GENRE information. In this example, a parameter describes the genres of various media items, and each item has a value for this parameter that corresponds to that item's genre. Exemplary genre values may include comedy, horror, drama, mystery, tragedy, and science fiction (sci-fi). The parameter chosen for control using a control bar may be displayed, for example, as part of the control bar itself (as in FIG. 4A) and/or in another part of the display. In some cases, a parameter identifier (e.g., a name or icon associated with the parameter) may be displayed. In FIG. 4A, a textual parameter identifier shows a user that “genre” is a parameter being controlled, and various items of information 410 provide choices of different genres. In this example, genres are organized by discrete category, and a user may use control bar 420 to choose an appropriate category (e.g., by moving sliders (not illustrated) within the control bar). A user may use control bar 420 to narrow the choice to a subset of the displayed choices, or widen the choice to a broader set of displayed choices. For example, in FIG. 4A, all media in the “drama” genre may be displayed as a single item of information 410. A user may select the “drama” item using control bar 420, which may cause the removal of non-drama information 410 from the display and the expansion of “drama” information to display more detailed information.

FIG. 4B illustrates a control bar 420 controlling the display of TIME information. Time information may include a television season, a sports season, a date of an event, a movie release date and the like. In FIG. 4B, control bar 420 informs the user that TIME information 410 is being displayed and controlled. In this example, TIME information 410 associated with various media items is categorized by decade (1950's, 1960's, etc.). A user may use control bar 420 to narrow the choice to a subset of the displayed choices, or widen the choice to a broader set of displayed choices. Thus, narrowing the choice to a single decade may result in the displayed information showing further detail (e.g., year by year).

FIG. 4C illustrates a control bar 420 controlling the display of information associated with a SPORT type. In this example, a user may choose among swimming, basketball, football, diving, luge, and biathlon. Control bar 420 may be used to narrow the choice to a subset of the displayed choices, or widen the choice to a broader set of displayed choices.

FIG. 4D illustrates a control bar 420 controlling the display of information 410 describing a LANGUAGE associated with various items. Displayed values of the LANGUAGE parameter include English, Tamil, Mandarin, Spanish, French, and Swedish. A user may use control bar 420 to narrow the choice to a subset of the displayed choices, or widen the choice to a broader set of displayed choices.

In some embodiments, a display may include several control bars, and control bars may be operated independently. For example, a display may include both a LANGUAGE control bar as in FIG. 4D and a TIME control bar as in FIG. 4B, and associated information may incorporate values associated with one or both of these parameters. A user wishing to view Swedish movies from the 1970's may use the LANGUAGE control bar to select “Swedish” and the TIME control bar “1970's.” Alternately, the user may first select “1970's” then select “Swedish.” Another control bar may be used to display and provide for the selection of MEDIA TYPES, such as “movies” or “television shows.”

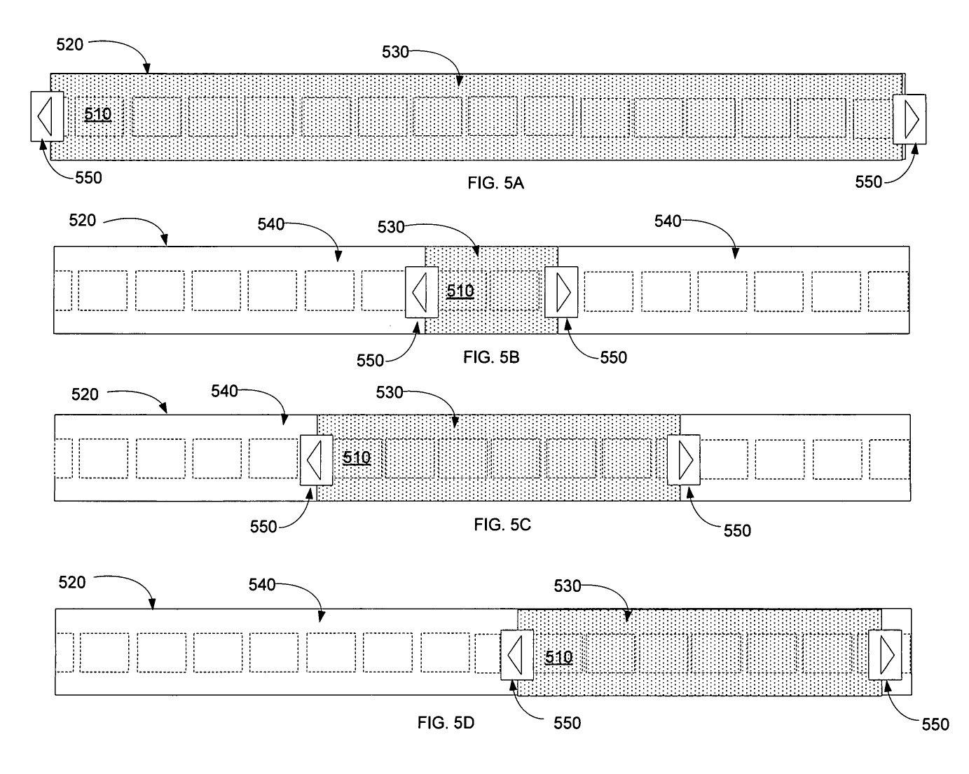

FIGS. 5A-D illustrate various operations of a control bar to select ranges of values for a controlled parameter. In these examples, corresponding information 510 is shown superimposed on the control bar 520 in each figure. In some embodiments, a control bar is integrated with its associated information on a display.

In FIG. 5A, sliders 550 are extended to the edges of control bar 520. Inside display region 530 substantially covers the entire length of control bar 520. As a result, substantially the entire range of values for the controlled parameter is displayed.

In FIG. 5B, sliders 550 have been brought toward each other to select a subset of values for the controlled parameter. Control bar 520 shows an inside display region 530 associated with the displayed values, and an outside display region 540 associated with values associated with information that would generally not currently be displayed.

In FIG. 5C, sliders 550 have been expanded apart to display a larger range of values as compared to FIG. 5B.

In FIG. 5D, the width of the range of displayed values is similar to that of FIG. 5C, but the location of the displayed range within the set of values is different. Such an operation of control bar 520 may include the discrete motion of each slider, or the parallel simultaneous motion of both sliders. Remote 130 (FIG. 1) may generally provide for one or more operations to control the control bars.

In various embodiments, changing the configuration of control bar 520 as shown in FIGS. 5A-5D may generally cause a concomitant change in the display of information. For example, information associated with the middle of the range within inside display region 530 may be displayed in the middle of the display when the control bar reflects the configuration of FIG. 5C. The same information may be displayed on the viewer's left side of the display when the control bar reflects the configuration of FIG. 5D.

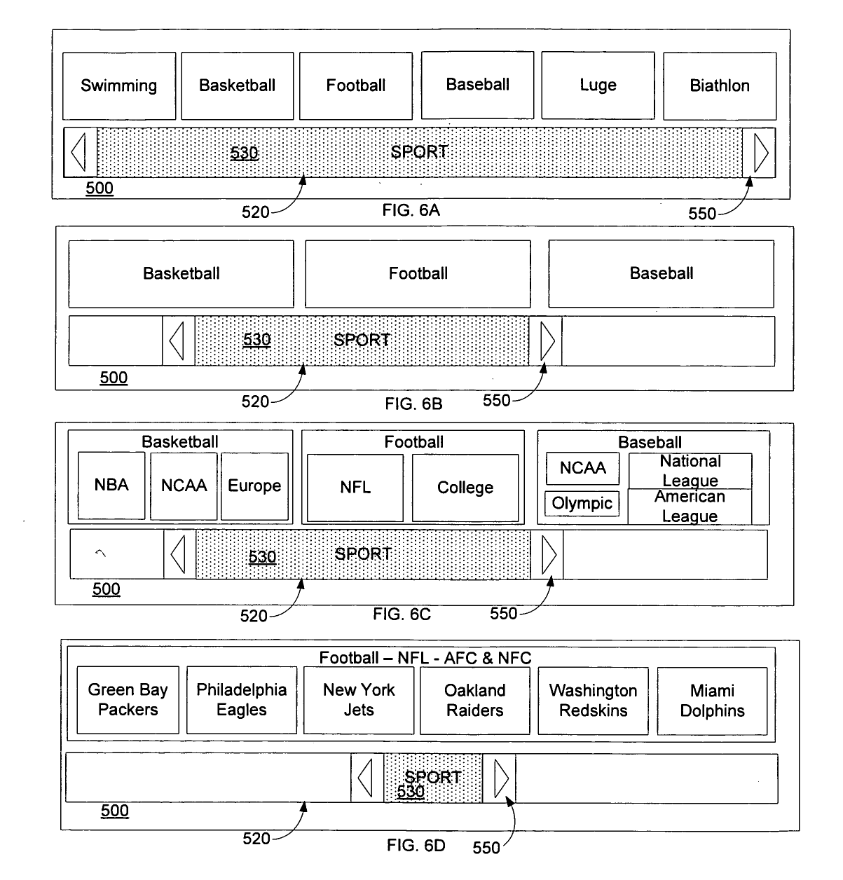

FIGS. 6A-6D illustrate a relationship between operation of a control bar and a change in displayed information. In FIGS. 6A-D, control bar 520 controls a SPORT parameter. Information associated with values of the SPORT parameter is displayed on display 500. In FIG. 6A, parameter values of swimming, basketball, football, baseball, luge, and biathlon are displayed as textual information as shown. Generally, values for which information is currently displayed may correspond to inside display region 530 in control bar 520.

In FIG. 6B, sliders 550 have been adjusted to select a subset of the values selected in FIG. 6A, as reflected in a smaller inside display region 530 as compared to FIG. 6A. Similarly, only the sports basketball, football, and baseball are displayed as part of display 500. In some embodiments, displayed information is rescaled in a way that optimizes the information content on display 500.

FIG. 6C illustrates one way in which narrowing a selection (e.g., zooming, or selecting a subset of values) may result in increased information content on display 500. As compared to FIG. 6A, sliders 550 may be adjusted to select a subset of values (in this example, basketball, football and baseball). Expansion of the relevant information associated with each of these values may include the addition of more detailed information. In this example, information regarding the league associated with each sport is displayed, providing increased granularity. Thus, “basketball” includes “NBA, NCAA, EUROPE” information; “football” information includes “NFL, COLLEGE” and “baseball” includes “NCAA, OLYMPIC, NATIONAL LEAGUE, AMERICAN LEAGUE.”

FIG. 6D illustrates an exemplary further narrowing of the displayed range of values as compared to FIG. 6C. In FIG. 6D, sliders 550 have been adjusted to select “football” for display, and to further select “NFL” within “football.” In this example, such an adjustment provides for even more detailed displayed information, and provides the user with a choice of teams (e.g., Green Bay Packers) and/or conferences (e.g, NFC, AFC).

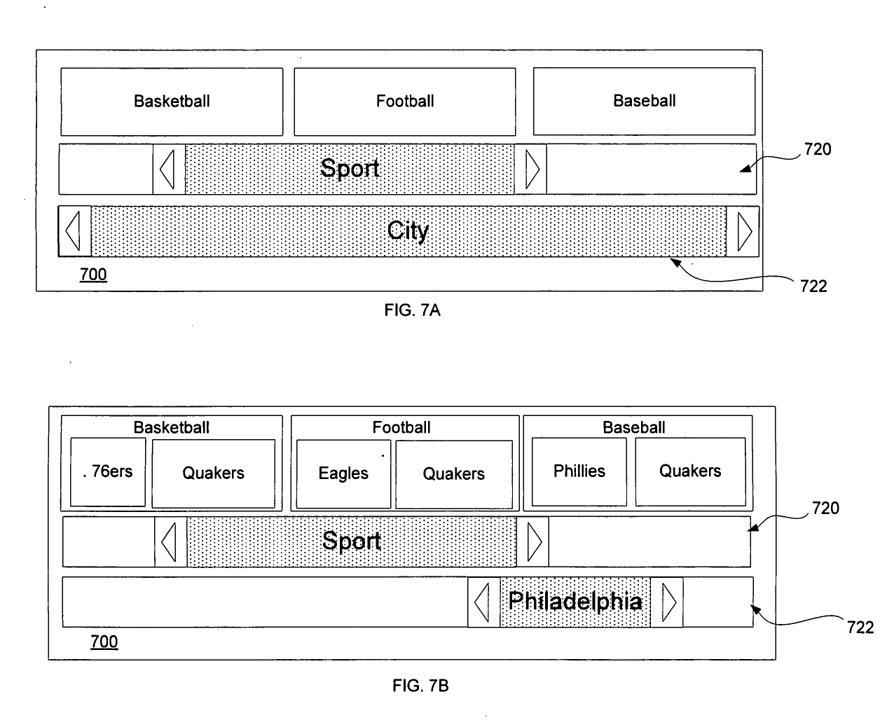

FIGS. 7A and 7B illustrate an operation of multiple control bars on displayed information. In these figures, two control bars are displayed, each controlling a range of values for a different parameter. Control bar 720 controls a SPORT parameter, and allows a user to select from among various sporting events. Control bar 722 controls a CITY parameter, and allows a user to select from among various cities with which an item of media is associated. In this example, the combination of control bars 720 and 722, controlling SPORT and CITY respectively, allows a user to control sports media items by both sport and the city with which a sport is associated (in this example, the home city of a team).

In FIG. 7A, control bar 722 is adjusted to display substantially all values for CITY. Control bar 720 is adjusted to display the sports basketball, football, and baseball. In some embodiments, the information associated with each sport may also include granularity describing the various cities having associated sports teams.

In FIG. 7B, control bar 722 has been adjusted to select a subset of cities (in this case, only the city of Philadelphia). In FIG. 7B, the selection of Philadelphia using control bar 722 results in the exclusion of information associated with sports teams other than those from Philadelphia. In this example, the information associated with each of “basketball” “football” and “baseball” is further refined to reflect the selection of CITY=Philadelphia, and each of these items of information displays Philadelphia-based teams (in this illustrative example, the Philadelphia '76ers, Philadelphia Eagles, Philadelphia Phillies, and the University of Pennsylvania Quakers). This example is illustrative, and not intended to be limiting (e.g., the Drexel Dragons might also be displayed in FIG. 7B).

In some embodiments, display 700 displays the intersection of sets of values associated with each control bar (i.e., the intersection of the “inside display regions” for the displayed control bars). In other embodiments, display 700 displays the union of sets of values associated with the control bars (i.e., the union of the “inside display regions” for the displayed control bars).

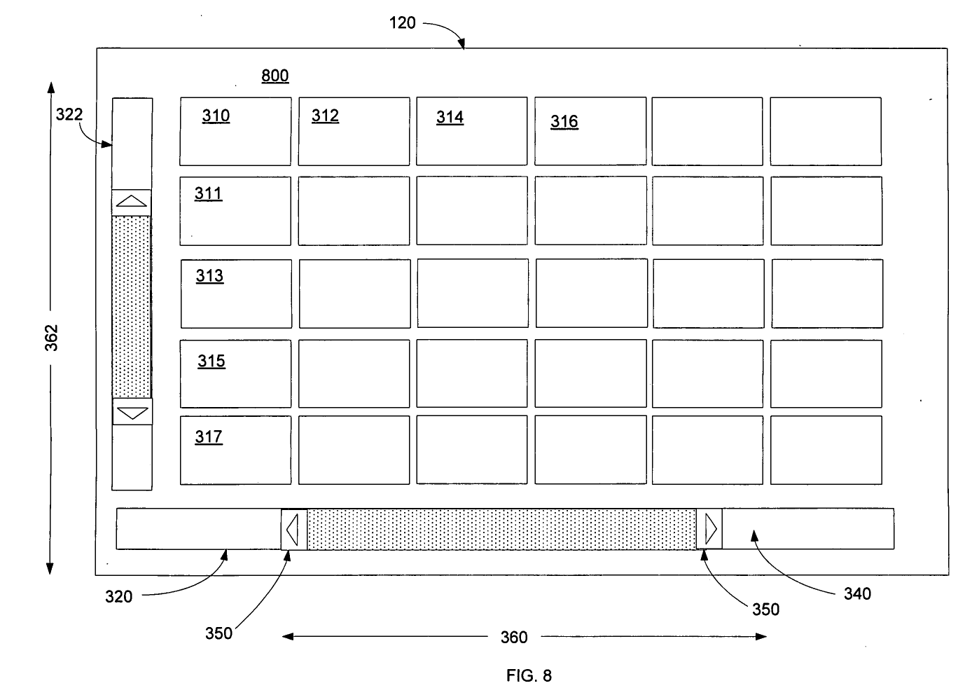

FIG. 8 illustrates another display utilizing multiple control bars. Display 800 includes two control bars 320 and 322, arranged in different directions. Information on display 800 (e.g., information 310-317) may be arranged similarly, with each item of information being arranged in a first direction 360 associated with control bar 320 and a second direction 362 associated with control bar 322.

An item of information may include information associated with or resulting from several parameters. In FIG. 8, control bar 320 controls a first parameter, and a position on control bar 320 in direction 360 may correspond to a value for the first parameter. Similarly, information may be correspondingly arranged on display 800, as represented by information 310, 312, 314, 316, and so forth.

In FIG. 8, control bar 322 controls a second parameter, and a position on control bar 322 in direction 362 corresponds to a value for the second parameter. Similarly, information may be correspondingly arranged on display 800 such that its respective position on the display is associated with a corresponding value for the second parameter, as represented by information 310, 311, 313, and 314. In some embodiments, the existence of an information item on display 800 indicates that the item is associated with the active regions of each respective control bar. In some embodiments, the position of each information item on display 800 is associated with its respective values for each parameter being controlled by a control bar.

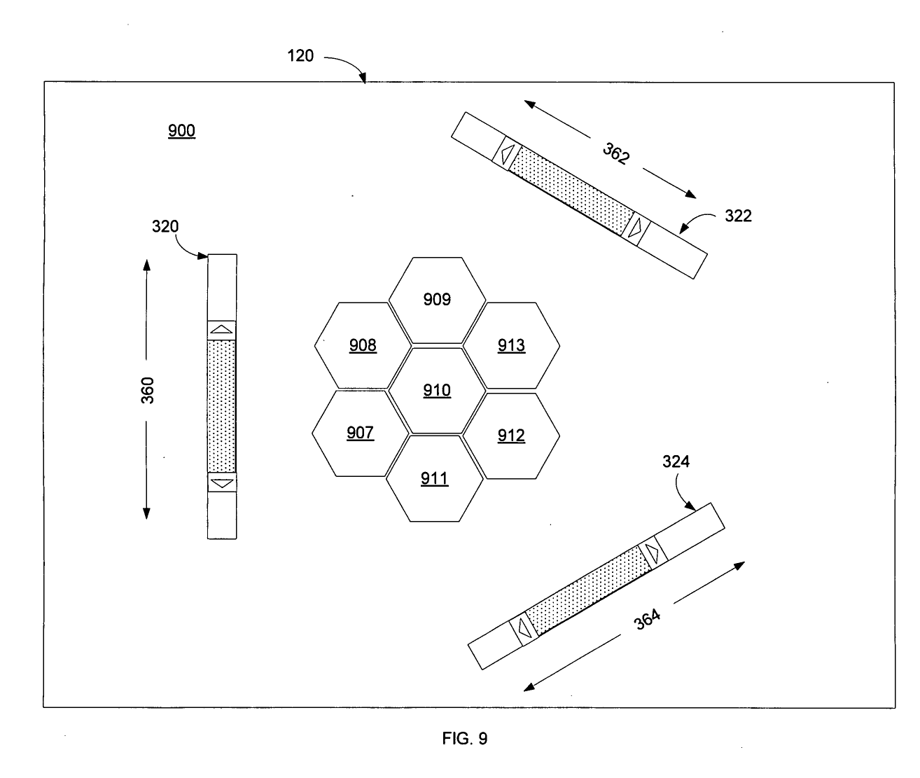

FIG. 9 illustrates another display utilizing multiple control bars. Display 900 includes three control bars 320, 322, and 324, arranged in different directions. Information (as represented by information 907-913) is arranged similarly, with each the position of each item of information being associated with its respective value for each parameter being controlled by the control bars. In this example, control bar 320 is oriented in direction 360, and the position of each item of information in direction 360 is associated with a value of a parameter being controlled by control bar 320. Similarly, control bar 322 is oriented in direction 362, and each information item is positioned on display 900 in a direction 362 that is associated with its respective value for the parameter being controlled by control bar 322. Finally, control bar control bar 324 is oriented in direction 364, and each item of information's position on display 900 in direction 364 is associated with its respective value for the parameter being controlled by control bar 324.

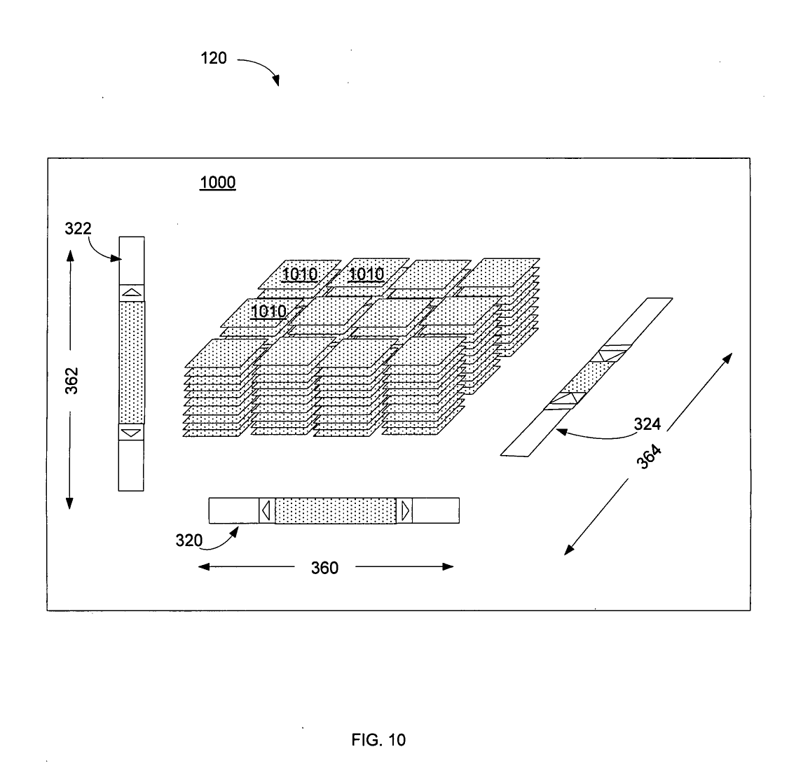

FIG. 10 illustrates another display utilizing multiple control bars. Display 1000 includes three control bars 320, 322, and 324, arranged in different directions. Information 1010 is arranged similarly, with the position of each item of information being associated with its respective value for each parameter being controlled by the control bars. In this example, control bar 320 is oriented in direction 360, and the position of each item of information in direction 360 is associated with a value of the parameter being controlled by control bar 320. Similarly, control bar 322 is oriented in direction 362, and the position of each information item on display 1000 in direction 362 is associated with its respective value for the parameter being controlled by control bar 322. Finally, control bar control bar 324 is oriented in direction 364, and the position of each information item on display 900 in direction 364 is associated with its respective value for the parameter being controlled by control bar 324.

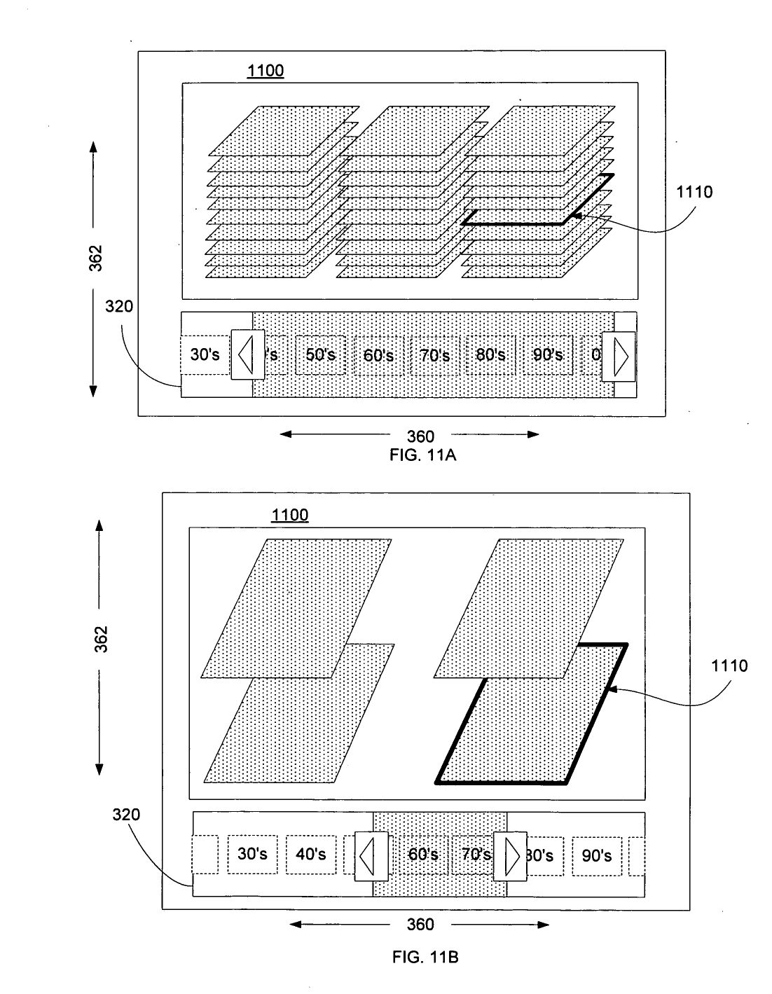

FIG. 11 illustrates an increase in information content with a reduced range of a controlled parameter. In FIG. 11A, a plurality of items of information are displayed on display 1100, and controlled by control bar 320. This plurality includes information 1100, displayed at a first level of information content. In FIG. 11B, control bar 320 has been operated to select a smaller range of values of the controlled parameter, and the information displayed on display 1100 reflects this smaller range. In FIG. 11B, information 1110 is displayed at a second level of information content, and the second level of information content includes more detail than the first level of information content.

FIGS. 11A and 11B also illustrate a change in information on display 1100 in a direction other than the direction being controlled by control bar 320. Control bar 320 is oriented in direction 360, and in this example, a change in control bar 320 may be manifest as a change in displayed information in both direction 360 and direction 362.

Various embodiments may enhance a user's ability to find desired media for viewing or listening. A trajectory through an N-dimensional parameter space may be efficiently created by graphically displaying information associated with parameters, allowing users to select a desired range of values for those parameters, and allowing a user to “zoom in” to one or more desired items of content (i.e., select a subset of the range, sometimes repeatedly). Thus, a display of media information may be dynamic and interactive, and provide a user with a wide variety of ways to choose media. A user may choose which parameter to control (e.g., via a control bar) from among many or even all of the parameters available to characterize items of content. A user may operate control bars to select desired ranges of values for parameters, and may dynamically change the parameters being controlled and/or the range of values being displayed. As such, a user may find media using a variety of identification processes.

In some embodiments, a “user preference” may be stored and/or loaded for a user. A user preference may included a preferred parameter, a preferred range of values, a preferred display style, a preferred number and/or orientation of control bars, or other preferences.

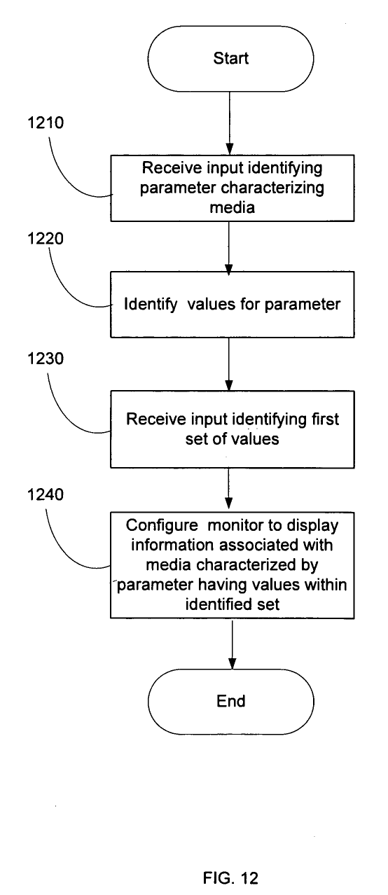

FIG. 12 is a flow chart illustrating a method, according to certain embodiments. In step 1210, input is received (e.g., from a user) that identifies one or more parameters. Typically, each parameter may characterize one or more media or other content.

In step 1220, a plurality of values for each inputted parameter is identified. A value may be associated with one or more media characterized by the parameter.

In step 1230, input (e.g., from a user) identifying a first set of the plurality of values is received. Often, such input may include identifying a subset that contains desired media.

In step 1240, a monitor may be configured to display information associated with media. Typically, the displayed information is associated with media that are characterized by the controlled identified parameter(s) and having values for those parameters within the first set.

In some cases, further input may be received that widens, narrows, or otherwise changes the size or boundaries of the first set. Typically, the monitor will then be reconfigured to display information associated with the newly selected set.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents.

What is claimed is:

1. A computer readable storage medium having embodied thereon a program executable by a processor to perform a method for displaying media information, the method comprising:
receiving a first input that identifies a parameter characterizing one or more media;
identifying a plurality of values for the parameter, each value associated with at least one of the media characterized by the parameter;
receiving a second input that identifies a first set of the plurality; and
generating instructions that instruct a monitor to display first information associated with the media having values within the first set.

2. The computer readable storage medium of claim 1, wherein the method further comprises generating instructions to display a parameter identifier.

3. The computer readable storage medium of claim 1, wherein the method further comprises generating instructions to display a control bar associated with the parameter.

4. The computer readable storage medium of claim 1, wherein the method further comprises generating instructions to display a control bar that displays the first set of the plurality of values for the parameter.

5. The computer readable storage medium of claim 4, wherein the control bar includes a slider that demarcates a boundary of the first set.

6. The computer readable storage medium of claim 5, wherein receiving the second input includes receiving input associated with operation of the slider.

7. The computer readable storage medium of claim 1, wherein identifying includes obtaining the plurality of values from a server.

8. The computer readable storage medium of claim 1, wherein receiving any of the first and second inputs includes receiving a signal from a remote control.

9. The computer readable storage medium of claim 1, wherein the monitor includes a television set.

10. The computer readable storage medium of claim 1, wherein the first information includes a genre associated with one or more media.

11. The computer readable storage medium of claim 1, wherein the first information includes one or more titles associated with one or more media.

12. The computer readable storage medium of claim 1, wherein the method further comprises displaying the first information on the monitor.

13. The computer readable storage medium of claim 1, wherein identifying includes receiving a third input.

14. The computer readable storage medium of claim 1, wherein the first information includes a plurality of categories, each category associated with a subset of the first set.

15. The computer readable storage medium of claim 14, wherein a category includes one or more release dates of the media associated with the category.

16. The computer readable storage medium of claim 15, wherein identifying includes identifying an ordering of the plurality, each subset is correspondingly ordered, and displaying the first information includes displaying the categories in a manner that corresponds to the ordering.

17. The computer readable storage medium of claim 1, wherein identifying includes identifying an ordering of the plurality, and the first information is displayed in a manner that corresponds to the ordering.

18. The computer readable storage medium of claim 1, wherein the method further comprises:
receiving third input that identifies a second set of the plurality; and
generating instructions to display second information associated with the items having values within the second set.

19. A media selection method comprising:
providing a database of media and associated information;
receiving a first input that identifies one or more parameters, each parameter characterizing one or more items of media;
identifying a range of values for each parameter, each value associated with one or more items of media characterized by the parameter;
receiving a second input that defines a first subset of each identified range;
generating instructions that cause a display device to display information associated with the items having values within each first subset;
receiving a third input that selects an item of media associated with any of the displayed information; and
playing the selected item of media content on a monitor.

20. The method of claim 19, wherein the monitor includes a television set.

21. The computer readable storage medium of claim 1, wherein the instructions are generated to display the first information on a mobile phone.

22. A set-top box for controlling a television, the set-top box comprising:
a computer readable storage medium having embodied thereon a program executable by a processor to perform a media selection method comprising:
providing a database of media and associated information;
receiving a first input that identifies one or more parameters, each parameter characterizing one or more items of media;
identifying a range of values for each parameter, each value associated with one or more items of media characterized by the parameter;
receiving a second input that defines a first subset of each identified range;
generating instructions that cause a display device to display information associated with the items having values within each first subset;
receiving a third input that selects an item of media associated with any of the displayed information; and
playing the selected item of media content on a monitor.
